(19) United States
(12) Patent Application Publication
(10) Pub. No.: US 2004/0108672 A1
(43) Pub. Date: Jun. 10, 2004

(54) Front suspension alignment cam reacted tool

(76) Inventor: Brian A. Enck, Sterling Heights, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/310,617

(22) Filed: Dec. 5, 2002

(51) Int. Cl. B62D 17/00

(52) U.S. Cl. 280/86.755

(57) ABSTRACT

A cam reaction tool includes a cam disc, and an extension coupled to the cam disc, the extension having a first coupling arrangement for coupling the cam tool to an arrangement for aligning a suspension system, and a second coupling arrangement for cooperating with a torque-applying tool. A method for aligning a front suspension system of a vehicle is provided in which a cam tool is fitted to an arrangement for adjusting the control arm of a vehicle suspension system and a torque is applied to the cam tool so as to adjust the control arm.

### FIELD OF THE INVENTION

The present invention relates generally to motor vehicle suspension systems. More particularly, the present invention relates to a cam reacted tool that can be used for front wheel suspension alignment.

### BACKGROUND INFORMATION

FIG. 1 shows a side elevation of a conventional suspension system manifold 5 for a front left wheel of a motor vehicle viewed from the front of the vehicle. A control arm 10 extends in a lateral direction between a wheel steering knuckle and the center of the vehicle and attaches to the steering knuckle—at the ball joint and controls the lateral and longitudinal position of the ball joint—within an adjustment range. Thus, the front wheel suspension may be aligned by adjusting the position of the lateral control arm 10 along a lateral direction A-A. The lateral control arm includes pivot arms having bushings 12, 14 (attached to respective pivot arms) for attachment to a chassis 20 of the vehicle. Typically, the bushings 12, 14 may include sleeves for receiving a bolt 22, 24. Each bolt 22, 24 passes through at least one approximately laterally oriented slot in the chassis 20 and may be fixed to the chassis structure with a nut and with one or two (when a cam washer is used on both sides of the chassis) cam washers 32, 34 on either side of the bushing sleeves 12, 14.

FIG. 2 is a schematic perspective view of a coupling between cam washer 34, bolt 24 and the chassis 20. As shown, the cam washer 34 is in a loosened position (e.g., by loosening a fastening nut on the other side of the nut-bolt coupling). The head of the bolt 28 is too wide to pass through the slot 36 while the threaded shaft of the bolt 28 passes through the chassis slot 40 to the bushing 14 of the control arm 10 and then could pass through another chassis slot leaving the end of the bolt shaft to be threaded with a nut. In the loosened position shown, the lateral position of the bolt can be adjusted by application of a torque on the head of the bolt 28 which may be performed using a wrench, for example. When the bolt 24 is turned counter clockwise or clockwise, the torque applied to the bolt head is transferred to the cam washer 34, which pushes the bolt leftward or rightward direction respectively as the bolt shaft impinges on the chassis slot. As the bolt moves laterally, the lateral control arm 10 is forced to move in a corresponding lateral direction via the bushing 14 and the pivot arm. Thus, by converting a rotational movement of the bolt head 28 into a translational movement of the bolt 28, the cam washer 34 facilitates lateral adjustment of the control arm 10 to align the front wheel suspension system.

One of the disadvantages of using cam washers to facilitate suspension manifold adjustments such as the lateral movement of the suspension control arm described, is that each pivot arm bushing requires one or more cam washers simply for adjustment purposes. As there are numerous such couplings throughout the manifold, use of cam washers in this context multiplies the number of components used in assembly, and thereby increases costs, weight and complexity.

It is therefore an object of the present invention to provide a cam reaction tool that allows lateral adjustment of the lateral control arm without the need to include cam washers in the couplings of the suspension control arm to the chassis.

### SUMMARY

The above and other beneficial objects of the present invention are most effectively attained by providing a cam reaction tool as described herein. In an example embodiment, the cam reaction tool includes a cam disc, and an extension coupled to the cam disc, the extension having a first coupling arrangement for coupling the cam tool to an arrangement for aligning a suspension system, and a second coupling arrangement for cooperating with a torque-applying tool. A method for aligning a front suspension system of a vehicle is provided in which a cam tool is fitted to an arrangement for adjusting the control arm of a vehicle suspension system and a torque is applied to the cam tool so as to adjust the control arm.

### BRIEF DESCRIPTION OF THE DRAWINGS

In the accompanying drawings:

FIG. 1 shows a side elevation of a conventional suspension manifold 5 for a front left wheel of a motor vehicle viewed from the front of the vehicle;

FIG. 2 is a schematic perspective view of the coupling between cam washer, bolt and the chassis illustrated in FIG. 1;

FIG. 3 shows a first example embodiment of a cam reaction tool according to the present invention;

FIG. 4 shows a cross-section of the cam tool of FIG. 3 taken along line B-B;

FIG. 5 shows a second example embodiment of a cam tool 70 according to the present invention; and

FIG. 6 shows a cross-section of the cam tool of FIG. 5.

### DETAILED DESCRIPTION

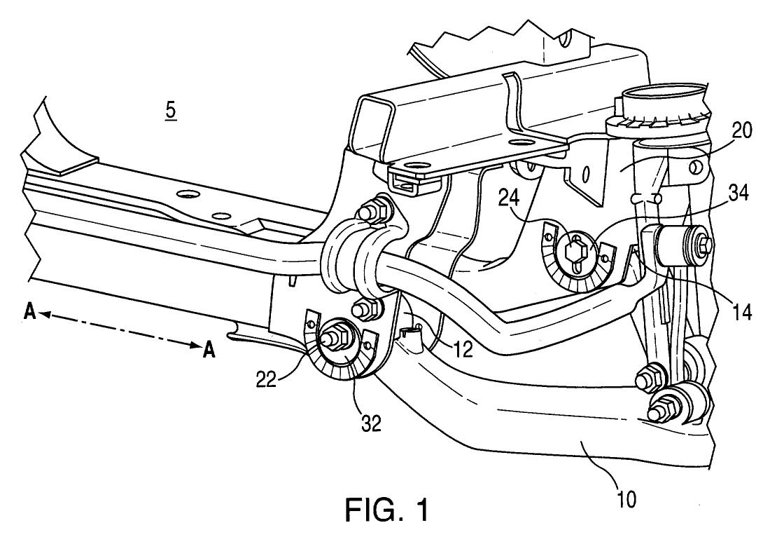

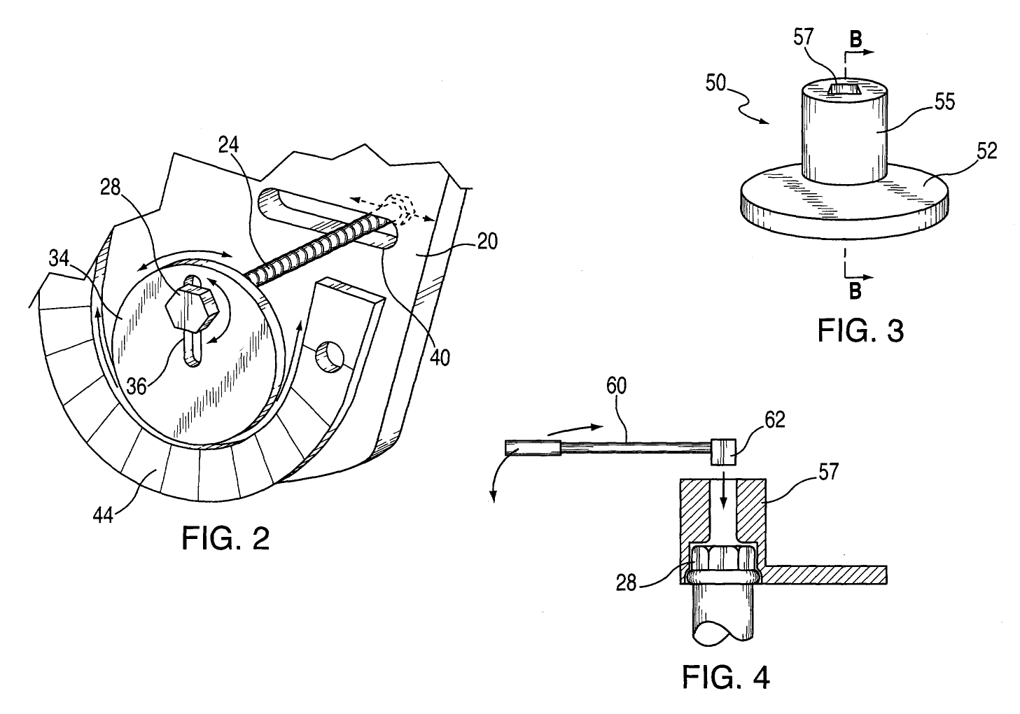

Those skilled in the art will gain an appreciation of the present invention from a reading of the following description when viewed in conjunction with the accompanying drawings of FIGS. 1 to 6, inclusive. The individual reference characters designate the same or similar elements throughout the several views.

Referring now to FIG. 3, there is shown a first example embodiment of a cam reaction tool according to the present invention. The tool 50 includes a circular or approximately circular cam disc 52, a cylindrical extension 55 that extends perpendicularly from a surface of the disc located near a radial edge on the disc's surface. The cylindrical extension 55 includes a hole that extends through the axial length of the extension with a varied cross-section. As shown in FIG. 4 which shows a cross-section of the cam tool 50 taken along line B-B, toward its bottom, the hole 57 is contoured to match the shaped features of a bolt head 28, so that the cylinder extension may be tightly fitted directly over the bolt head. During an alignment operation, the cylinder extension of the cam tool is placed over the bolt head 28 of a bushing as shown, and the outer surface of the cam tool disc 52 comes into contact with a horseshoe element as shown in FIG. 1. A wrench tool 60 having a protruding feature 62 design to snuggly fit into the top of the cylinder extension hole 57 may be used to turn the cam tool 50, which causes the tool disc 52 to swing laterally along the upward ledge of the horseshoe in the same manner as the cam washer in response to a rotational torque. The lateral movement of the cam tool 50 then moves a loosed bolt within the slot of the chassis to adjust the lateral position of the control arm. In this manner, the cam tool substitutes for the function of the cam washers and fully provides for a conversion of a rotational movement of the bolt head into a translational movement of the bolt and the control arm, dispensing with the need to install the cam washers at the couplings between the lateral control arm and the chassis. The cylindrical extension 55 may also include external facets to accept a regular drive tool.

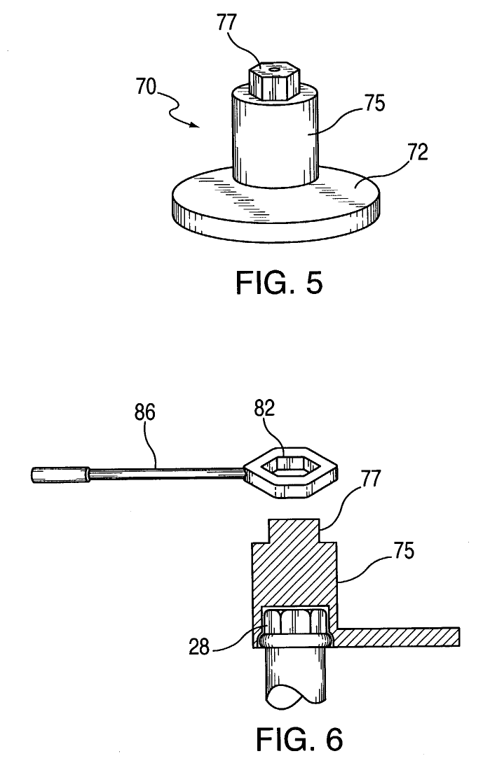

FIG. 5 shows a second example embodiment of a cam tool 70 according to the present invention. Cam tool 70 includes a circular or approximately approximately circular cam disc 72, a cylindrical extension 75 that extends perpendicularly from a surface of the disc from an outer radial location on the disc's surface. Toward its bottom, the cylindrical extension 55 includes a hole contoured to fit tightly on the head of a bolt 28. The cam tool also includes a hexagonal or nut-shaped feature 77 at the top of the cylindrical section 75. As shown in FIG. 6, according to the second example embodiment, a regular closed eye, open eye or socket wrench 80 of having a receptacle 82 of appropriate size for fitting onto a nut can be placed over and around the nut-shaped feature 77 to turn the cam tool 70 in order to adjust the alignment of the control arm as discussed above. The cylindrical extension 75 may also include external facets to accept a regular drive tool.

The example embodiments above provide the advantages that the cam washer features normally included in vehicle suspension systems can be substituted with a single reusable tool without affecting manufacturing or assembly processes, which may reduce costs. Additionally, by removing cam washers from the control arm adjustment arrangement, quality may be improved by reducing the potential for a loose joint occurring due to galling or mis-assembly. The tool can easily be adapted for service throughout the life of the vehicle. Furthermore, the cam tool of the present invention may be adapted to provide a convenient arrangement to adjust any adjustment arrangement having adjustment slots.

Thus, the several aforementioned objects and advantages of the present invention are most effectively attained. Those skilled in the art will appreciate that many modifications of the example embodiments described hereinabove may be made without departing from the spirit and scope of the invention. Although several example embodiments of the invention have been described and disclosed in detail herein, it should be understood that this invention is in no sense limited thereby and that its scope is to be determined by that of the appended claims.

What is claimed is:

1. A cam reaction tool for aligning a control arm of a suspension system, the suspension system having an arrangement configured to adjust a position of the control arm with respect to a vehicle chassis, comprising:
a cam disc; and
an extension coupled to the cam disc, the extension having a first coupling configured to couple the cam tool to the adjustment arrangement, and a second coupling configured to cooperate with a torque-applying tool.

2. The cam reaction tool of claim 1, wherein the suspension system includes a front wheel suspension system, and the adjustment arrangement includes a bolt arranged to fasten a bushing of the control arm to the vehicle chassis.

3. The cam reaction tool of claim 1, wherein the second coupling arrangement of the extension includes a contoured hole arranged to tight fittingly receive a corresponding contoured feature of a torque-applying tool.

4. The cam reaction tool of claim 1, wherein the second coupling arrangement of the extension includes a nut-shaped feature adapted to be received into a wrench.

5. The cam reaction tool of claim 2, wherein the first coupling includes a contoured hole arranged to snuggly receive a head of the bolt in the adjustment arrangement.

6. The cam reaction tool of claim 1, wherein the extension is a cylinder extending perpendicularly from and at an edge of a surface of the cam disc.

7. A method for aligning a front suspension system of a vehicle, the front suspension system including an arrangement configured to adjust a position of a control arm with respect to a vehicle chassis, the method comprising:
fitting a cam tool to the adjustment arrangement; and
applying a torque to the cam tool to adjust the control arm in a linear direction.

8. The method of claim 7, wherein the adjustment arrangement includes a bolt, the bolt coupled to the control arm and laterally adjustable with respect to the chassis, and the cam tool includes a first coupling configured to tightly couple to the bolt.

9. The method of claim 8, further comprising:
fitting the first coupling of the cam tool to the head of the bolt; and
moving the cam tool along an at least partially lateral path so as to laterally adjust the position of the bolt.

10. The method of claim 8, wherein the cam tool includes a second coupling arranged to tightly couple to a torque-applying tool.

11. The method of claim 10, wherein the second coupling includes a receptacle arranged to receive a contoured feature of a torque-applying tool.

12. The method of claim 10, wherein the second coupling includes a nut-shaped feature for coupling to a wrench.

13. A front wheel suspension system comprising:
a lateral control arm;
a coupling arranged to couple the lateral control arm to the chassis, the coupling including an adjustment arrangement configured to adjust a position of the lateral control arm with respect to the chassis, the adjustment arrangement not including a cam washer.

14. The front wheel suspension system of claim 13, further comprising:
a nut and bolt fastening coupled directly to the chassis arranged to couple the lateral control arm to the chassis.
